(19) United States
(12) Patent Application Publication
(10) Pub. No.: US 2023/0216627 A1
(43) Pub. Date: Jul. 6, 2023

(54) UE-ASSISTED SINGLE FREQUENCY NETWORK (SFN) MANAGEMENT

(71) Applicants: Runxin WANG, San Diego, CA (US); Muhammad Sayed Khairy ABDELGHAFFAR, San Diego, CA (US); Yu ZHANG, San Diego, CA (US); Krishna Kiran MUKKAVILLI, San Diego, CA (US); Hwan Joon KWON, San Diego, CA (US); QUALCOMM Incorporated, San Diego, CA (US)

(72) Inventors: Runxin Wang, San Diego, CA (US); Muhammad Sayed Khairy Abdelghaffar, San Jose, CA (US); Yu Zhang, San Diego, CA (US); Krishna Kiran Mukkavilli, San Diego, CA (US); Hwan Joon Kwon, San Diego, CA (US)

(21) Appl. No.: 17/996,755

(22) PCT Filed: Jun. 28, 2020
(86) PCT No.: PCT/CN2020/098562

§ 371 Date: Oct. 20, 2022

(51) Int. Cl. H04L 5/00; H04W 24/10

(52) U.S. Cl. CPC H04L 5/0035; H04L 5/0048; H04L 5/0091; H04W 24/10

(57) ABSTRACT

Aspects of the disclosure relate to radio access networks with a capability to dynamically reconfigure a number of transmission-reception points (TRPs) in a single-frequency network (SFN) based on channel measurements. In one example, a mobile device receives a configuration message including a plurality of transmission configuration indicator (TCI) states, and potentially further including an indication identifying one or more of the TCI states as main TCI states. The message may further include an indication that it includes the plurality of TCI states. The UE receives a downlink traffic channel and demodulates the traffic channel based on only a subset of the TCI states (e.g., the main TCI state (s)). The UE further measures one or more channel parameters corresponding to each TCI state of the plurality of TCI states, and transmits a channel state information report based on the channel parameters. Other aspects, embodiments, and features are also claimed and described.

### TECHNICAL FIELD

The technology discussed below relates generally to wireless communication systems, and more particularly, to single frequency networks (SFN). Embodiments can provide and enable techniques for proving dynamically flexible SFN scheme configuration.

### INTRODUCTION

Wireless communication networks come in a variety of forms and provide a variety of different functions and features beyond cellular phone calls. One example of a wireless network scheme that has gained recent attention is that of a single frequency network (SFN). SFNs are typically employed for wireless point-to-multipoint communication, such as digital television broadcasts, multimedia broadcast multicast services (MBMS), etc. With SFN, a set of multiple SFN transmitters in a wireless communication network may synchronously transmit the same signal in the same time period. Accordingly, a receiver may receive the SFNed transmissions while basically assuming that there is a single transmitter. By virtue of a SFN feature, a wireless communication network may provide for increased coverage. That is, inter-cell interference between from SFN cells (interference from a neighbor transmitter, experienced by a receiver that is receiving a signal from a proximate transmitter) can provide constructive gain, rather than disturbing the receiver. However, a SFN feature generally has strict delay conditions due to the propagation time difference from different SFN transmitters to a given receiver.

When a wireless communication network provides a SFN feature, the SFN transmitters coordinate their respective SFN transmissions (e.g., timing synchronization, and communication of data to transmit such that the transmitters transmit the same symbols). In some examples, transmitters may achieve such coordination via inter-transmitter backhaul communication links. And in some examples, transmitters may achieve such coordination via mutual backhaul communication with a suitable SFN control node. As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects, the disclosure relates to radio access networks with a capability to dynamically reconfigure a number of transmission-reception points (TRPs) in a single-frequency network (SFN) based on channel measurements. In some examples, a user equipment (UE) be configured to transmit capability information indicating support of a SFN scheme switching feature.

In some aspects of the disclosure, a UE may receive a configuration message that includes a plurality of transmission configuration indicator (TCI) states, and potentially further including an indication identifying one or more of the TCI states as main TCI states. The message may further include an indication that it includes the plurality of TCI states. The UE may receive a downlink traffic channel and demodulate the traffic channel based on only a subset of the TCI states (e.g., the main TCI state(s)). The UE may further measure one or more channel parameters corresponding to each TCI state of the plurality of TCI states, and may transmit a channel state information report based on the channel parameters.

In another example, a UE may receive one or more reference signals (RS) from each of multiple TRPs. Based on the RSs, the UE may determine a channel parameter corresponding to each one of the TRPs. The UE may then determine one or more preferred SFN schemes, and/or one or more preferred TRPs based on the channel parameters. The UE may transmit a report based on the determined channel parameters (e.g., including the preferred SFN scheme(s) and/or TRP(s)). In response to this report, the UE may receive an indication of a change from a first SFN scheme to a second SFN scheme (e.g., changing the number of TRPs employed in the SFN scheme).

In another example, a network node (e.g., a base station, a gNB, a TRP, etc.) may transmit on a downlink traffic channel to a UE utilizing a first SFN scheme. The network node may receive channel measurement information corresponding to respective channels between the UE and the TRPs. For example, the network node may receive a channel state information report from the UE. In another example, the network node may receive information indicating TCI states corresponding to neighbor TRPs. Based on the channel measurement information, the network node may determine to change from the first SFN scheme to a second SFN scheme, and transmit an indication of this to the UE. The network node may further transmit configuration information to the UE, including multiple TCI states. In an example where the network node is a TRP, the TRP may transmit the information including the TCI states corresponding to the neighbor TRPs together with a TCI state corresponding to itself. The network node may then transmit on the downlink traffic channel utilizing the second SFN scheme.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some embodiments.

FIG. 5 is a block diagram conceptually illustrating an example of a hardware implementation for a scheduling entity according to some aspects of the disclosure.

FIG. 6 is a block diagram conceptually illustrating an example of a hardware implementation for a scheduled entity according to some aspects of the disclosure.

FIG. 7 is a conceptual illustration for describing a transparent single-frequency network (SFN) scheme and a non-transparent SFN scheme.

FIG. 8 is a schematic illustration of changing channel characteristics with a fast-moving mobile device in a high-speed train.

FIG. 9 is a flow chart illustrating an exemplary process for a network-based SFN scheme flexibility feature according to some aspects of the disclosure.

FIG. 10 is a flow chart illustrating an exemplary process for a UE-based SFN scheme flexibility feature according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

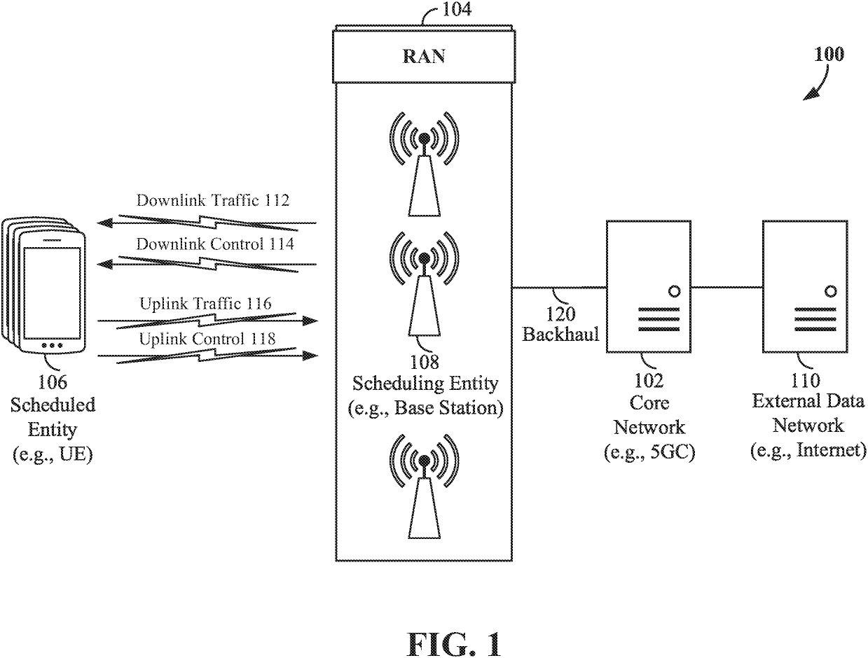

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable radio access technology (RAT) or technologies to provide radio access to the UE 106. Generally, a RAT refers to a type of technology or communication standard utilized for radio access and communication over a wireless air interface. Just a few examples of RATs include GSM, UTRA, E-UTRA (LTE), Bluetooth, and Wi-Fi. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 supports wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

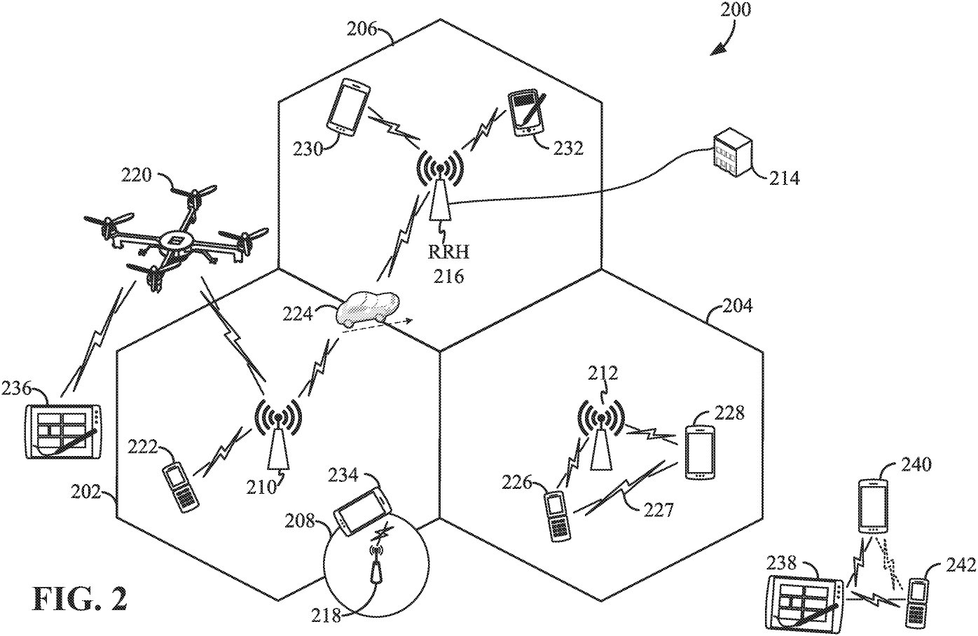

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints. Broadly, such base stations, RRHs, small cells, etc. may be referred to as transmission reception points (TRP). That is, a TRP may be considered a set of geographically co-located antennas (e.g. antenna array (with one or more antenna elements)) supporting transmission point (TP) and/or reception point (RP) functionality. TP functionality may correspond to a set of geographically co-located transmit antennas (e.g. antenna array (with one or more antenna elements)) for a cell or part of a cell. Similarly, RP functionality may correspond to a set of geographically co-located receive antennas (e.g. antenna array (with one or more antenna elements)) for a cell or part of a cell.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In some examples, a RAN such as the RAN 200 may be configured for a single-frequency network (SFN) function. With SFN, a set of multiple SFN transmitters, e.g., corresponding to TRPs in the RAN 200, may synchronously transmit the same signal in the same time period. Accordingly, a receiver may receive the SFNed transmissions while basically assuming that there is a single transmitter. By virtue of a SFN feature, a RAN may provide for increased coverage. That is, inter-cell interference (ICI) from SFN cells can provide constructive gain. However, a SFN feature generally has strict delay conditions due to the propagation time difference from different SFN transmitters to a given receiver. These delay conditions are often addressed with the use of a longer cyclic prefix (CP), and/or a greater number of pilots or reference signals.

When a RAN provides a SFN feature, the SFN TRPs coordinate their respective SFN transmissions (e.g., timing synchronization, and communication of data to transmit such that the TRPs transmit the same symbols). In some examples, TRPs may achieve such coordination via inter-TRP backhaul communication links such as an X2 interface. And in some examples, TRPs may achieve such coordination via mutual backhaul communication with a suitable SFN control node.

SFN is typically employed for wireless point-to-multipoint communication, such as digital television broadcasts, multimedia broadcast multicast services (MBMS), etc. While 3GPP Rel-15 Specifications deferred such PTM schemes until later releases, 3GPP created a number of Study Items to develop PTM support for 5G NR in Rel-16 and beyond.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RAT). For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

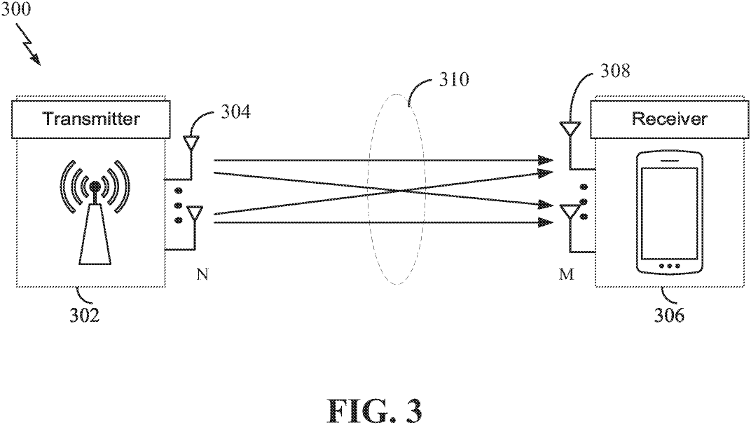

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, the amplitude and phase of each antenna in an array of antennas may be precoded, or controlled to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N × M signal paths 310 from the transmit antennas 304 to the receive antennas 308. Similar to beamforming, a MIMO transmitter may apply precoding to an antenna array to enable a receiver to demultiplex a plurality of spatially multiplexed data streams. Each of the transmitter 302 and the receiver 306 may be implemented, for example, within a scheduling entity 108, a scheduled entity 106, or any other suitable wireless communication device.

To support beamforming or MIMO, a transmitting device may determine the precoding of the transmitted data stream or streams based, e.g., on known channel state information of the channel on which the transmitting device transmits the data stream(s). For example, the transmitting device may transmit one or more suitable reference signals (e.g., a channel state information reference signal, or CSI-RS) that the receiving device may measure. The receiver may then report measured channel quality information (CQI) back to the transmitting device. This CQI generally reports the current communication channel quality, and in some examples, a requested transport block size (TBS) for future transmissions to the receiver. In some examples, the receiver may further report a precoding matrix indicator (PMI) back to the transmitting device. This PMI generally reports the receiving device’s preferred precoding matrix for the transmitting device to use, and may be indexed to a predefined codebook. The transmitting device may then utilize this CQI/PMI to determine a suitable precoding matrix for transmissions to the receiver.

In Time Division Duplex (TDD) systems, the UL and DL are reciprocal, in that each uses different time slots of the same frequency bandwidth. Therefore, in TDD systems, a base station may assign a rank for DL MIMO transmissions based on an UL SINR measurement (e.g., based on a sounding reference signal (SRS) or other pilot signal transmitted from the UE). Based on the assigned rank, the base station may then transmit a channel state information reference signal (CSI-RS) with separate sequences for each layer to provide for multi-layer channel estimation. From the CSI-RS, the UE may measure the channel quality across layers and resource blocks. The UE may then transmit a CSI report (including, e.g., CQI, RI, and PMI) to the base station for use in updating the rank and assigning resources for future downlink transmissions.

When a transmitter 302 is configured for MIMO, the number of layers, or the rank of a transmission, corresponds to a number of antenna ports. Here, each antenna port may be defined such that the channel over which a symbol on the antenna port is conveyed can be inferred from the channel over which another symbol on the same antenna port is conveyed. For example, an antenna port may refer to a channel model, as defined by a reference signal transmitted over the channel using that antenna port. Each antenna port is mapped onto an antenna (e.g., a single dipole or an array of dipoles).

Two antenna ports are said to be quasi co-located (QCL) if properties of the channel over which a symbol on one antenna port is conveyed can be inferred from the channel over which a symbol on the other antenna port is conveyed. Thus, two antenna ports that are QCL are correlated with one another. A UE may utilize QCL information to support beam-level mobility, for estimating frequency and time offsets due to Doppler shift and delay, etc.

In some examples, a network may provide a transmission configuration indicator (TCI) to a UE. A TCI is a configuration information element that provides a UE with a set of TCI state parameters. These TCI state parameters may provide for one or more TCI states for a PDSCH/DM-RS. Here, each TCI state may indicate one or two QCL relationships. Each QCL relationship indicates a QCL type, and a RS (e.g., SSB, CSI-RS, TRS, etc.) that is QCL with the PDSCH/DMRS having that QCL type. A network may provide TCI state parameters utilizing any suitable signaling, including but not limited to a MAC-CE and/or a DCI.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station 210 may multiplex DL transmissions to UEs 222 and 224 utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

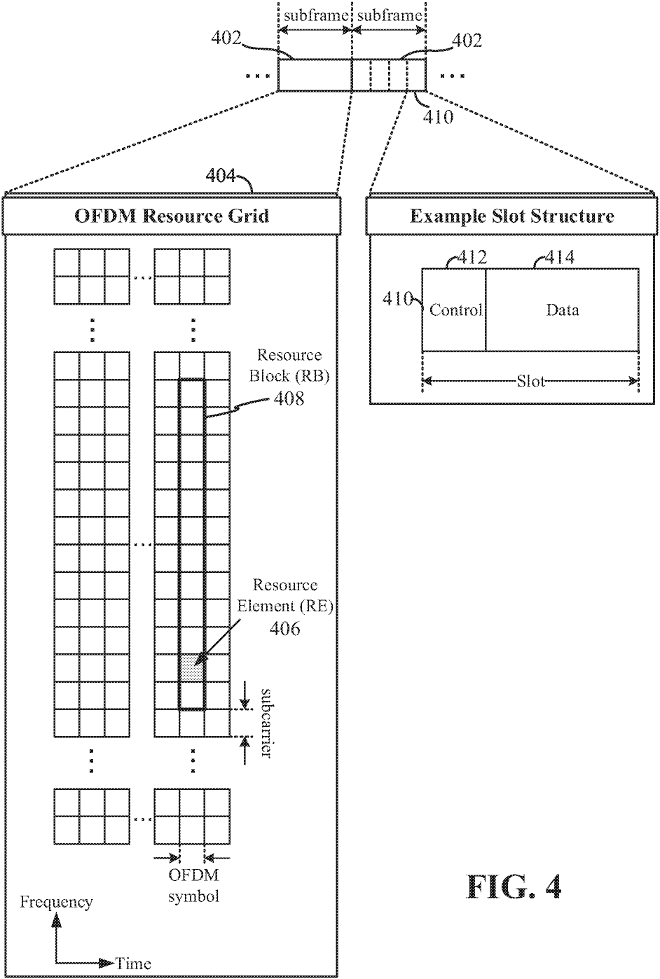

Various aspects of the present disclosure will be described with reference to an OFDM waveform, schematically illustrated in FIG. 4. An OFDM air interface may be defined according to a two-dimensional grid of resource elements, defined by separation of resources in frequency by defining a set of closely spaced frequency tones or subcarriers, and separation in time by defining a sequence of symbols having a given duration. By setting the spacing between the tones based on the symbol rate, intersymbol interference can be eliminated. OFDM channels can provide for high data rates by allocating a data stream in a parallel manner across multiple subcarriers. In some examples, an OFDM waveform may be configured with a cyclic prefix (CP). That is, a multipath environment degrades the orthogonality between subcarriers because symbols received from reflected or delayed paths may overlap into the following symbol. A CP addresses this problem by copying the tail of each symbol and pasting it onto the front of the OFDM symbol. In this way, any multipath components from a previous symbol fall within the effective guard time at the start of each symbol, and can be discarded. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier × 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A UE generally utilizes only a subset of the resource grid 404. An RB may be the smallest unit of resources that can be allocated to a UE. Thus, the more RBs scheduled for a UE, and the higher the modulation scheme chosen for the air interface, the higher the data rate for the UE.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); tracking reference signals (TRS); etc.

The synchronization signals PSS and SSS (collectively referred to as SS), and in some examples, the PBCII, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission. A TB may include, for example, one or more MAC protocol data units (PDUs) and/or one or more MAC control elements (MAC-CE).

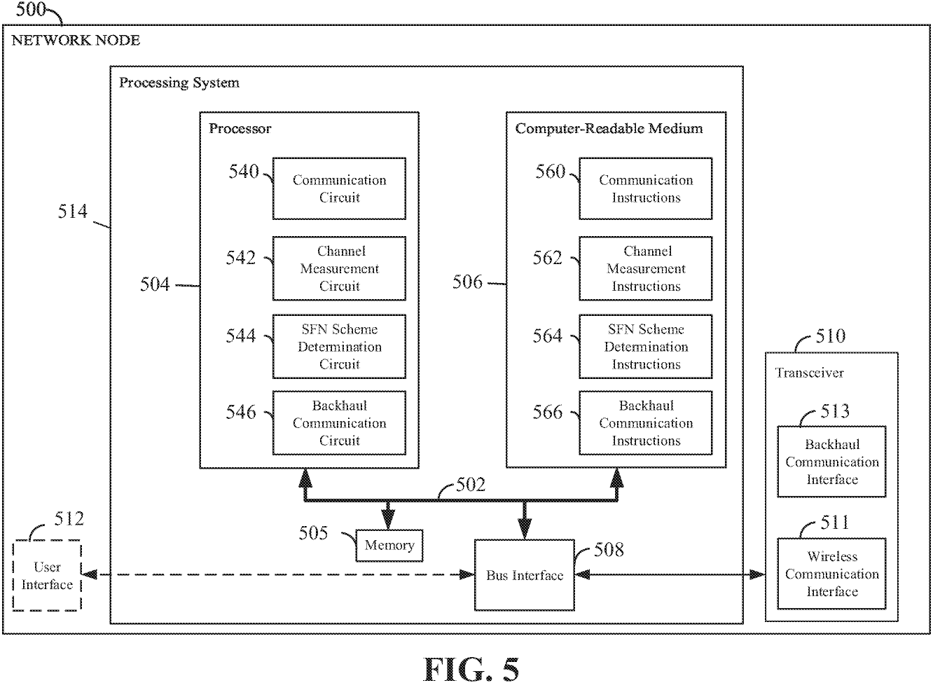

FIG. 5 is a block diagram illustrating an example of a hardware implementation for a network node 500 employing a processing system 514. For example, the network node 500 may be a user equipment (UE) as illustrated in any one or more of FIGS. 1, 2, and/or 3. In another example, the network node 500 may be a scheduling entity (e.g., gNB), a base station, or other transmission reception point (TRP) as illustrated in any one or more of FIGS. 1, 2, and/or 3. In another example, the network node 500 may be an SFN controller communicatively coupled to a plurality of TRPs.

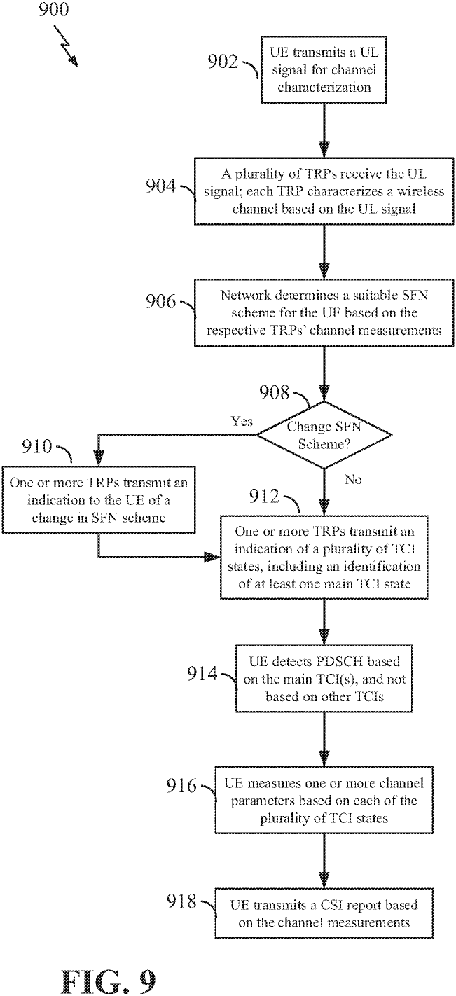

The network node 500 may be implemented with a processing system 514 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 500 may be configured to perform any one or more of the functions described herein. That is, the processor 504, as utilized in a network node 500, may be configured (e.g., in coordination with the memory 505) to implement any one or more of the processes and procedures described below and illustrated in FIGS. 9 and/or 10.

In this example, the processing system 514 may be implemented with a bus architecture, represented generally by the bus 502. The bus 502 may include any number of interconnecting buses and bridges depending on the specific application of the processing system 514 and the overall design constraints. The bus 502 communicatively couples together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a communication interface or means for communicating with various other apparatus over a transmission medium. For example, the transceiver 510 may include a wireless communication interface 511 configured for wireless transmission and/or reception over a radio access network. The transceiver 510 may additionally or alternatively include a backhaul communication interface 513 configured for communication over a suitable backhaul network. Depending upon the nature of the network node, a user interface 512 (e.g., keypad, display, speaker, microphone, joystick) may also be provided. Of course, such a user interface 512 is optional, and may be omitted in some examples, such as a base station.

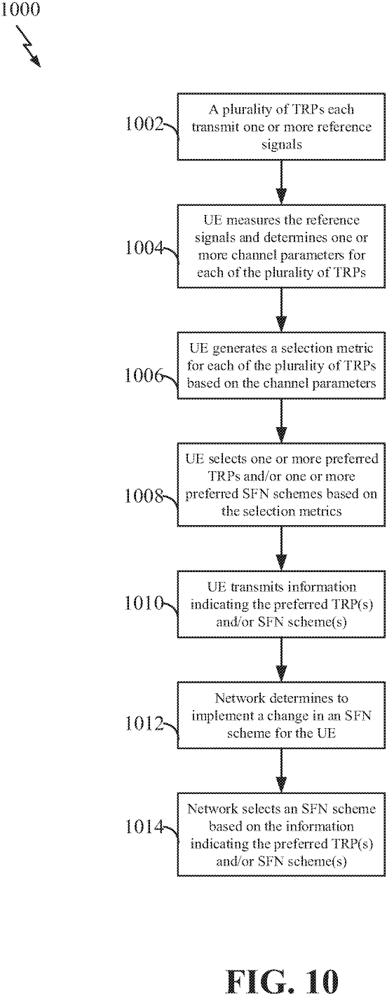

In some aspects of the disclosure, the processor 504 may include communication circuitry 540 configured (e.g., in coordination with the memory 505) for various functions, including, for example, configuring and/or transmitting on a downlink traffic channel and/or downlink control channel, receiving channel measurement information, and/or receiving neighbor TRP TCI state information (e.g., via the wireless communication interface 511 and/or via an associated network node via the backhaul communication interface 513). For example, the communication circuitry 540 may be configured to implement one or more of the functions described below in relation to FIG. 9, including, e.g., blocks 910, 912, and/or 918. The communication circuitry 540 may further be configured to implement one or more of the functions described below in relation to FIG. 10, including, e.g., bocks 1002 and/or 1010. The processor 504 may further include channel measurement circuitry 542 configured for various functions, including, for example, measuring or characterizing a wireless channel based on an uplink signal received from a UE. For example, the channel measurement circuitry 542 may be configured to implement one or more of the functions described below in relation to FIG. 9, including, e.g., block 904. The processor 504 may further include SFN scheme determination circuitry 544 configured for various functions, including, for example, determining an SFN scheme or determining to change an SFN scheme, e.g., based on channel measurement information. For example, the SFN scheme determination circuitry 544 may be configured to implement one or more of the functions described below in relation to FIG. 9, including, e.g., block 906. The SFN scheme determination circuitry 544 may further be configured to implement one or more of the functions described below in relation to FIG. 10, including, e.g., bocks 1012 and/or 1014. The processor 504 may further include backhaul communication circuitry 546 configured for various functions, including, for example, receiving channel measurement information from a TRP, receiving TCI state information from a TRP, transmitting (e.g., via an associated TRP), downlink information to a UE, via a neighbor TRP, receiving via an associated TRP channel measurement information from a UE, and/or receiving, via a neighbor TRP, preferred SFN scheme information and/or preferred TRP information from a UE. For example, the backhaul communication circuitry 546 may be configured to implement one or more of the functions described below in relation to FIG. 9, including, e.g., blocks 906, 910, 912, and/or 918. The backhaul communication circuitry 546 may further be configured to implement one or more of the functions described below in relation to FIG. 10, including, e.g., bock 1010.

The processor 504 is responsible for managing the bus 502 and general processing, including the execution of software stored on the computer-readable medium 506. The software, when executed by the processor 504, causes the processing system 514 to perform the various functions described below for any particular apparatus. The computer-readable medium 506 and the memory 505 may also be used for storing data that is manipulated by the processor 504 when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the computer-readable storage medium 506 may store computer-executable code that includes communication instructions 560 that configure a network node 500 for various functions, including, e.g., configuring and/or transmitting on a downlink traffic channel and/or downlink control channel, receiving channel measurement information, and/or receiving neighbor TRP TCI state information (e.g., via the wireless communication interface 511 and/or via an associated network node via the backhaul communication interface 513). For example, the communication instructions 560 may be configured to cause a network node 500 to implement one or more of the functions described below in relation to FIG. 9, including, e.g., blocks 910, 912, and/or 918. The communication instructions 560 may further be configured to cause a network node 500 to implement one or more of the functions described below in relation to FIG. 10, including, e.g., bocks 1002 and/or 1010. The computer-readable storage medium 506 may further store computer-executable code including channel measurement instructions 562 that configure a network node 500 for various functions, including, e.g., measuring or characterizing a wireless channel based on an uplink signal received from a UE. For example, the channel measurement instructions 562 may be configured to cause a network node 500 to implement one or more of the functions described below in relation to FIG. 9, including, e.g., block 904. The computer-readable storage medium 506 may further store computer-executable code including SFN scheme determination instructions 564 that configure a network node 500 for various functions, including, e.g., determining an SFN scheme or determining to change an SFN scheme, e.g., based on channel measurement information. For example, the SFN scheme determination instructions 564 may be configured to cause a network node 500 to implement one or more of the functions described below in relation to FIG. 9, including, e.g., block 906. The SFN scheme determination instructions 564 may further be configured to cause a network node 500 to implement one or more of the functions described below in relation to FIG. 10, including, e.g., bocks 1012 and/or 1014. The computer-readable storage medium 506 may further store computer-executable code including backhaul communication instructions 566 that configure a network node 500 for various functions, including, e.g., receiving channel measurement information from a TRP, receiving TCI state information from a TRP, transmitting (e.g., via an associated TRP), downlink information to a UE, via a neighbor TRP, receiving via an associated TRP channel measurement information from a UE, and/or receiving, via a neighbor TRP, preferred SFN scheme information and/or preferred TRP information from a UE. For example, the backhaul communication instructions 566 may be configured to cause a network node 500 to implement one or more of the functions described below in relation to FIG. 9, including, e.g., blocks 906, 910, 912, and/or 918. The backhaul communication instructions 566 may further be configured to cause a network node 500 implement one or more of the functions described below in relation to FIG. 10, including, e.g., bock 1010.

In one configuration, the network node 500 includes means for transmitting on a downlink traffic channel and/or downlink control channel, means for receiving on an uplink traffic channel and/or uplink control channel, means for determining an SFN scheme and/or determining to change an SFN scheme, means for communicating with one or more neighbor TRPs and/or communicating with an SFN controller, and/or means for performing a channel measurement based on a received signal. In one aspect, the aforementioned means may be the processor(s) 504 shown in FIG. 5 configured to perform the functions recited by the aforementioned means. In another aspect, the aforementioned means may be a circuit or any apparatus configured to perform the functions recited by the aforementioned means.

Of course, in the above examples, the circuitry included in the processor 504 is merely provided as an example, and other means for carrying out the described functions may be included within various aspects of the present disclosure, including but not limited to the instructions stored in the computer-readable storage medium 506, or any other suitable apparatus or means described in any one of the FIGS. 1, 2, and/or 3, and utilizing, for example, the processes and/or algorithms described herein in relation to FIGS. 9 and/or 10.

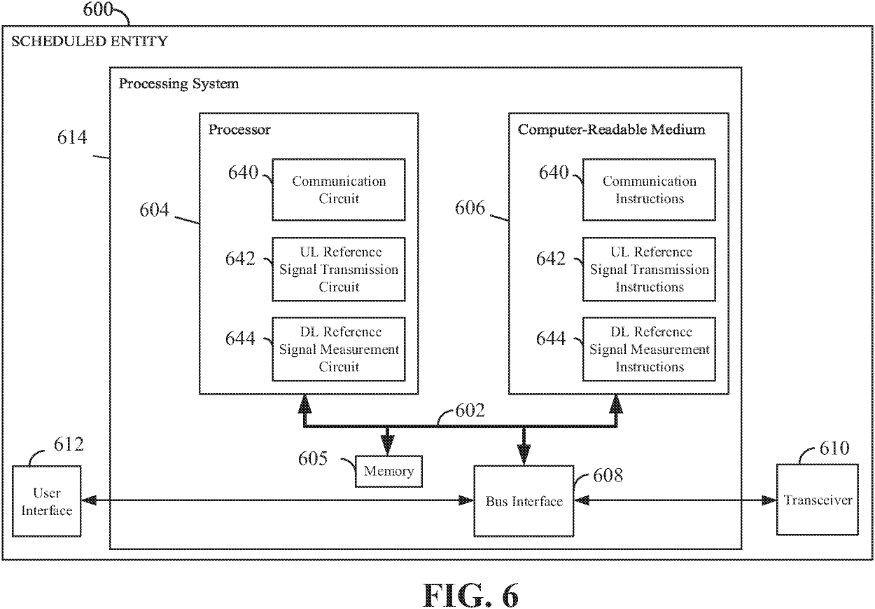

FIG. 6 is a conceptual diagram illustrating an example of a hardware implementation for an exemplary scheduled entity 600 employing a processing system 614. In accordance with various aspects of the disclosure, an element, or any portion of an element, or any combination of elements may be implemented with a processing system 614 that includes one or more processors 604. For example, the scheduled entity 600 may be a user equipment (UE) as illustrated in any one or more of FIGS. 1, 2, and/or 3.

The processing system 614 may be substantially the same as the processing system 514 illustrated in FIG. 5, including a bus interface 608, a bus 602, memory 605, a processor 604, and a computer-readable medium 606. Furthermore, the scheduled entity 600 may include a user interface 612 and a transceiver 610 substantially similar to those described above in FIG. 5. That is, the processor 604, as utilized in a scheduled entity 600, may be configured (e.g., in coordination with the memory 605) to implement any one or more of the processes described below and illustrated in FIGS. 9 and/or 10.

In some aspects of the disclosure, the processor 604 may include communication circuitry 640 configured (e.g., in coordination with the memory 605) for various functions, including, e.g., transmitting and/or receiving (e.g., via the transceiver 610) on an uplink traffic channel and/or an uplink control channel. For example, the communication circuitry 640 may be configured to implement one or more of the functions described below in relation to FIG. 9, including, e.g., blocks 912, 914, and/or 918. The communication circuitry 640 may further be configured to implement one or more of the functions described below in relation to FIG. 10, including, e.g., block 1010. The processor 604 may further include UL reference signal transmission circuitry 642 configured (e.g., in coordination with the memory 605) for various functions, including, e.g., transmitting one or more UL reference signals (e.g., an SRS). For example, the UL reference signal transmission circuitry 642 may be configured to implement one or more of the functions described below in relation to FIG. 9, including, e.g., block 902. The processor 604 may further include DL reference signal measurement circuitry 644 configured (e.g., in coordination with the memory 605) for various functions, including, e.g., measuring or characterizing a DL reference signal (e.g., an SS, a CSI-RS, a DM-RS, a TRS, etc.); generating channel parameters and/or channel state information based on the measurement; generating a selection metric for a TRP based on the measurement; and/or selecting one or more preferred TRPs and/or one or more preferred SFN schemes based on selection metrics. For example, the DL reference signal measurement circuitry 644 may be configured to implement one or more of the functions described below in relation to FIG. 9, including, e.g., block 914 and/or 916. The DL reference signal measurement circuitry 644 may further be configured to implement one or more of the functions described below in relation to FIG. 10, including, e.g., blocks 1004, 1006, and/or 1008.

And further, the computer-readable storage medium 606 may store computer-executable code that includes communication instructions 660 that configure a UE 600 for various functions, including, e.g., transmitting on an uplink traffic channel and/or an uplink control channel; and/or receiving and demodulating a downlink traffic channel and/or a downlink control channel (e.g., via the transceiver 610). For example, the communication instructions 660 may be configured to cause a UE 600 to implement one or more of the functions described below in relation to FIG. 9, including, e.g., blocks 912, 914, and/or 918. The communication instructions 660 may further be configured to cause a UE 600 to implement one or more of the functions described below in relation to FIG. 10, including, e.g., block 1010. The computer-readable storage medium 606 may further store computer-executable code that includes UL reference signal transmission instructions 662 that configure a UE 600 for various functions, including, e.g., transmitting one or more UL reference signals (e.g., an SRS). For example, the UL reference signal transmission instructions 662 may be configured to cause a UE 600 to implement one or more of the functions described below in relation to FIG. 9, including, e.g., block 902. The computer-readable storage medium 606 may further store computer-executable code that includes DL reference signal measurement instructions 664 that configure a UE 600 for various functions, including, e.g., measuring or characterizing a DL reference signal (e.g., an SS, a CSI-RS, a DM-RS, a TRS, etc.); generating channel parameters and/or channel state information based on the measurement; generating a selection metric for a TRP based on the measurement; and/or selecting one or more preferred TRPs and/or one or more preferred SFN schemes based on selection metrics. For example, the DL reference signal measurement instructions 664 may be configured to cause a UE 600 to implement one or more of the functions described below in relation to FIG. 9, including, e.g., block 914 and/or 916. The DL reference signal measurement instructions 664 may further be configured to cause a UE 600 to implement one or more of the functions described below in relation to FIG. 10, including, e.g., blocks 1004, 1006, and/or 1008.

In one configuration, the UE 600 includes means for transmitting on an uplink traffic channel and/or uplink control channel; means for receiving and demodulating a downlink traffic channel and/or downlink control channel; means for measuring a downlink reference signal; means for determining a channel parameter based on a TCI state and/or based on a downlink reference signal; and/or means for determining a preferred SFN scheme and/or a preferred TRP based on suitable input parameters. In one aspect, the aforementioned means may be the processor(s) 604 shown in 6 configured to perform the functions recited by the aforementioned means. In another aspect, the aforementioned means may be a circuit or any apparatus configured to perform the functions recited by the aforementioned means.

Of course, in the above examples, the circuitry included in the processor 604 is merely provided as an example, and other means for carrying out the described functions may be included within various aspects of the present disclosure, including but not limited to the instructions stored in the computer-readable storage medium 606, or any other suitable apparatus or means described in any one of the FIGS. 1, 2, and/or 3, and utilizing, for example, the processes and/or algorithms described herein in relation to FIGS. 9 and/or 10.

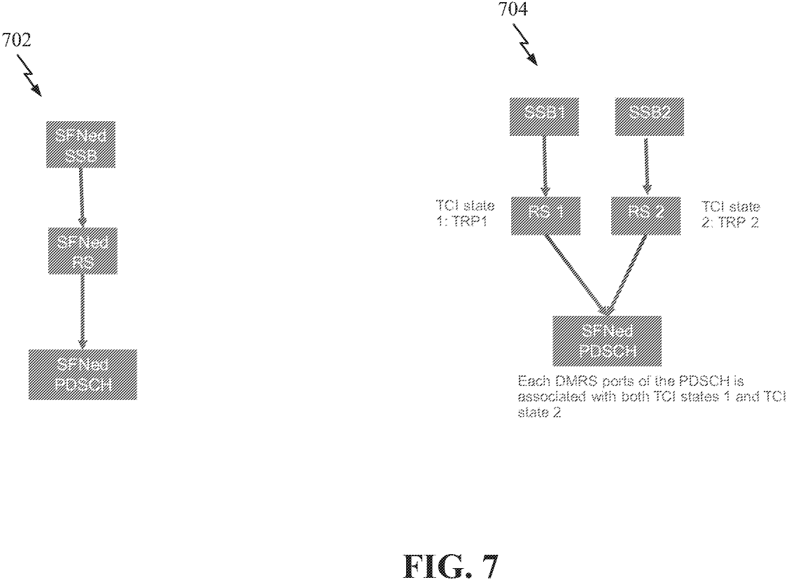

As discussed above, a RAN may be configured to provide a single-frequency network (SFN) feature. According to various aspects of the present disclosure, an SFN may be configured according to a variety of different SFN schemes. For example, FIG. 7 conceptually illustrates a transparent SFN scheme 702 and a non-transparent SFN scheme 704. Within the present disclosure, reference to SFN scheme flexibility may include a capability to switch or transition between transparent and non-transparent SFN schemes, single-TRP (e.g., non-SFN) schemes, and any other suitable SFN schemes.

As illustrated in FIG. 7, a transparent SFN scheme 702 may provide for a plurality of TRPs to transmit SFNed sync signal blocks (SSB); SFNed reference signals (e.g., TRS); and SFNed data transmissions (e.g., PDSCH). Further, with a transparent SFN scheme 702, a network may provide a UE with only a single transmission configuration indicator (TCI) to indicate which RS is QCL with the DM-RS and PDSCH. Accordingly, based on the TCI, a UE may be limited to generating a composite channel estimate from the SFNed TRSs, and from a 1-port DM-RS. However, this may nevertheless provide advantages over SFN schemes because the transparent SFN scheme 702 provides for a simplified procedure, with no extra DM-RS overhead and no additional impact to already-existing Specifications.

As further illustrated in FIG. 7, a non-transparent SFN scheme 704 may provide for each of a plurality of TRPs to transmit a separate SSB, and a separate reference signal (e.g., TRS). However, the TRPs transmit SFNed data transmissions (e.g., PDSCH). With a non-transparent SFN scheme 704, a network may provide a UE with a plurality of TCI states, corresponding to the respective TRPs. Accordingly, a UE may estimate channel parameters (e.g., a Doppler profile) of each TRP independently, based on the corresponding TCI state. This can provide for improved channel estimation performance relative to the transparent SFN scheme 702. Similar to the transparent SFN scheme 702, the non-transparent SFN scheme 704 may provide for a UE to utilize a single-port DM-RS in demodulating the SFNed PDSCH. Accordingly, like the transparent SFN scheme 702, the non-transparent SFN scheme 704 calls for no extra DM-RS overhead. However, the non-transparent SFN scheme 704 may still result in the UE generating a composite channel estimate based on a 1-port DM-RS. And further, a non-transparent SFN scheme 704 may not be backward-compatible with other SFN schemes, such as the transparent SFN scheme 702.

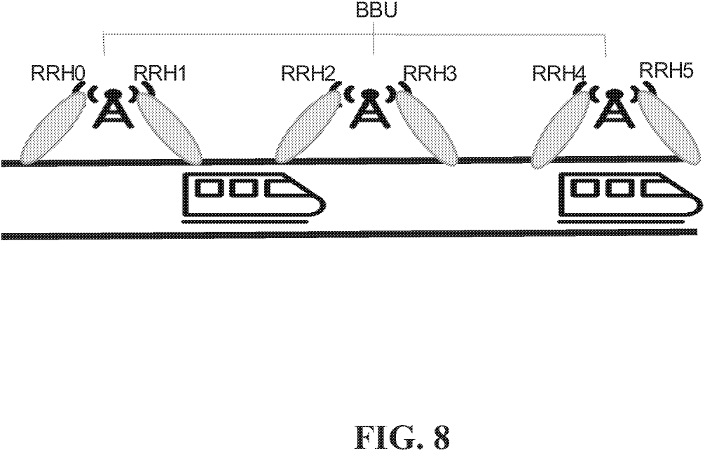

If a given UE has a capability to utilize different SFN schemes, such as a single-TRP (non-SFN) scheme, a transparent SFN scheme 702, a non-transparent SFN scheme 704, etc., different SFN schemes may provide the UE with better performance at different times, e.g., when a UE is on a high-speed train. As illustrated in FIG. 8, at one time, such a fast-moving UE may be located between RRH1 and RRH2, and a SFN scheme may be most suitable; but very quickly afterward, the fast-moving UE may be located directly beside a single TRP, and a non-SFN scheme may be most suitable. However, existing networks do not provide for dynamic flexibility in selecting a suitable SFN scheme at different times or locations. Furthermore, existing networks do not take advantage of a UE’s capability to measure the channel with each of a plurality of TRPs to select a suitable SFN scheme. Accordingly, various aspects of the present disclosure provide for a flexible SFN scheme switching feature, in which a network may employ UE assistance information for SFN scheme selection.

In the following discussion, a network-based SFN scheme flexibility feature is described. For example, a gNB or base station may be configured to transmit a control signal (e.g., a MAC-CE, a DCI, etc.) to a UE to coordinate a change in the SFN scheme. In addition, a UE-based SFN scheme flexibility feature is described. For example, a UE may be configured to transmit a signal to a gNB or base station, to help the base station estimate which SFN scheme will provide for better performance. And further, UE capability signaling with respect to UE support for one or both of the above SFN scheme flexibility features is described.

### Network-Based SFN Scheme Flexibility

In current 3GPP Specifications, to configure a UE to receive an SFN transmission, a network may transmit one or more MAC-CE/DCI messages to indicate multiple TCI states, corresponding to multiple TRPs, for a PDSCH transmission. As discussed above, a TCI state generally informs a UE which reference signal is QCL with a DM-RS transmitted with the PDSCII. For example, in a single-TRP case, only a single RS is QCL with the DM-RS. However, in a SFN case, each SFN TRP may transmit a RS that is QCL with the DM-RS. Thus, when a network provides a UE with multiple TCI states corresponding to multiple TRPs, the UE can estimate the DM-RS, and detect the PDSCII, based on each one of the QCL reference signals as indicated by the respective TCI states. In this manner, a UE can improve its channel estimation performance in receiving a SFN transmission.

According to an aspect of the present disclosure, to configure a UE to receive an SFN transmission, a network may transmit a configuration message that includes multiple TCI states. In some examples, the network may provide these TCI state indications together. For example, a single TRP may utilize an RRC message, a MAC-CE, a DCI, and/or any other suitable control signaling to provide a configuration message that includes multiple TCI states to a UE. Here, the TRP may receive information indicating TCI states corresponding to one or more other TRPs via a suitable backhaul communication. This information may be provided directly from those TRPs via a suitable inter-TRP communication interface (e.g., an X2 interface), via a SFN control node, or in any other suitable manner. In a further aspect, the network may provide the UE with an indication that the configuration message includes multiple TCI states. This indication may, but need not necessarily be included in the same configuration message as the one including the multiple TCI states.

In some examples, a network may further identify what is referred to herein as a main TCI. That is, although a network may provide multiple TCIs to a UE, the network may identify one or more of those TCIs as a main TCI. For example, a network may include a 1-bit information element (IE) in a MAC-CE/DCI to indicate whether the corresponding message provides a plurality of TCI states. In an event where multiple TCI states are provided, a UE may identify a subset (e.g., a predetermined subset known to the network) of the TCI states (e.g., the first TCI state received) as a main TCI state. In another example, rather than the 1-bit IE described above, a network may include one or more n-bit IE(s) to identify one or more TCI states as main TCI states. For example, each indicated TCI state may be associated with a suitable n-bit IE that indicates whether the corresponding TCI state is a main TCI state. In another example, such an n-bit IE may be configured with an index value, representing a corresponding indexed TCI state from among the multiple TCI states. Those of ordinary skill in the art will recognize that the above examples are only provided for the purpose of explanation, and that many other configurations of n-bit IE(s) may suitably identify a subset of one or more TCI states as main TCI states.

Thus, a UE may receive and utilize a plurality of TCI states in an SFN network. According to a further aspect of the present disclosure, a UE may detect (e.g., receive, demodulate, process, characterize, etc.) a data transmission (e.g., PDSCH) based only on the main TCI state(s), and not based on other TCI state(s) that are not identified as a main TCI. And furthermore, a UE may measure and report a channel state, a Doppler shift, and/or any other suitable channel parameter(s) based on each one of the multiple TCI states, and not only the main TCI state(s). That is, a UE may reduce its processing load by detecting a data transmission based only on a subset of received TCI states, rather than detecting the data transmission based on the full set of received TCI states. And furthermore, by measuring and reporting channel parameters based on each one of the multiple TCI states, a network may make a fully informed determination of a suitable SFN scheme based on channel parameters corresponding to each one of the SFN TRPs.

In a further aspect of the present disclosure, a TRP may utilize a MAC-CE, a DCI, and/or any other suitable control signaling to transmit an indication to a UE of a change in SFN scheme. In some examples, a TRP may provide such a SFN scheme change indication in the same message that carries the multiple TCI states, described above.

In various aspects, a change in SFN scheme may correspond to a fallback from a multi-TRP SFN scheme to a single-TRP scheme. Here, the network may select a suitable TRP (e.g., the TRP measured to have the best quality) as the single TRP. In another example, a change in SFN scheme may correspond to a reduction in a number of TRPs participating in an SFN scheme, or an increase in a number of TRPs participating in an SFN scheme. In still another example, a change in SFN scheme may correspond to a switch between a transparent SFN scheme and a non-transparent SFN scheme, as described above. In further examples, a change in SFN scheme may correspond to some combination of the above, and/or any other suitable change to an SFN scheme. Here, the indication of a change in SFN scheme may include an indication of one or more selected TRPs for the SFN scheme, e.g., based on channel measurements.

FIG. 9 is a flow chart illustrating an exemplary process 900 for a network-based SFN scheme flexibility feature in accordance with some aspects of the present disclosure. As described below, some or all illustrated features may be omitted in a particular implementation within the scope of the present disclosure, and some illustrated features may not be required for implementation of all embodiments. In some examples, the process 900 may be carried out by the network node 500 illustrated in FIG. 5. In some examples, the process 900 may be carried out by the UE 600 illustrated in FIG. 6. In some examples, the process 900 may be carried out by any suitable apparatus or means for carrying out the functions or algorithm described below.

At block 902, a UE may transmit an UL signal for channel characterization. For example, a UE may transmit a suitable reference signal such as an SRS. At block 904, a plurality of TRPs may receive the UL signal. Here, each TRP may characterize a wireless channel based on the received UL signal. And at block 906, a network, of which the plurality of TRPs are a part, may determine a suitable SFN scheme for the UE based on the respective TRPs′ channel measurements.

In the example illustrated in FIG. 9, it is assumed that the relevant link operates on a TDD carrier. In a TDD carrier, UL and DL transmissions are carried over the same channel, and thus, channel measurements based on signals transmitted in one direction (e.g., TRP measurements of an SRS) can reliably be utilized for configuring transmissions in the other direction (e.g., TRP transmissions of a PDSCH). However, one of ordinary skill in the art will recognize that this is merely one illustrative example, and the same concepts can be applied in, e.g., an FDD carrier. However, with an FDD carrier, UL transmissions are made at a different frequency than DL transmissions, and thus, the UL experiences a channel having different characteristics than the DL. Accordingly, while in the example in FIG. 9, a network configures the SFN scheme for DL transmission of the PDSCH based on a UE’s UL transmission of an SRS, this is merely one example. In another example corresponding to an FDD carrier, a network may configure the SFN scheme for DL transmission of the PDSCH based on a CSI report received from the UE. Here, TRP(s) may transmit a suitable DL reference signal to the UE (e.g., CSI-RS), and the UE may perform DL channel measurements based on those received signals. The UE may then transmit a CSI report including information on the DL channel measurements, which the network may then utilize to configure the SFN scheme for transmission of the PDSCH.

At block 908, if the network determines, based on the TRPs′ channel measurements, to change the SFN scheme, then the process may proceed to block 910. Here, one or more of the TRPs may transmit an indication to the UE of a change in the SFN scheme, as described above (e.g., utilizing a MAC-CE, a DCI, etc.).

If the network determines at block 908 not to change the SFN scheme, then the process may skip block 910 and proceed to block 912. At block 912, one or more TRPs may transmit an indication of a plurality of TCI states, including an identification of at least one TCI state as a main TCI state, as described above. At block 914, the UE may detect a downlink transmission (e.g., PDSCH) based on the main TCI states, and not based on other TCI states (those not identified as main TCI states) signaled to the UE. And at block 916, the UE may measure one or more channel parameters based on each of the plurality of TCI states, e.g., including the main TCI states and other TCI states not identified as main TCI states. Thus, at block 918, the UE may transmit a message (e.g., a CSI report) including information indicating the one or more measured channel parameters, as described above. Accordingly, based on the channel parameters, the network may suitably configure PDSCH transmissions from the various TRPs to improve performance.

### Ue-Assisted SFN Scheme Selection

In current 3GPP Specifications, a gNB selects a suitable SFN scheme for UEs. That is, the UE does not assist the gNB in its selection of a suitable SFN scheme.

According to an aspect of the present disclosure, a UE may transmit or report an indication of one or more preferred TRPs, e.g., based on multiple TCI measurements.

That is, a UE may measure reference signals (e.g., CSI-RS, TRS) from multiple TRPs based on multiple TCI states. In this way, the UE can determine one or more channel parameters, such as a Doppler shift estimation, an RSRP measurement, an RSSI measurement, etc., for each one of a plurality of TRPs. Further, a UE may measure any other DL reference signal to determine any suitable channel parameter(s) to determine which TRP or TRPs can provide better performance.

Accordingly, a UE may transmit a message or report including an indication of a preferred TRP for fallback (e.g., single TRP) operation. That is, based on the UE’s determination of suitable channel parameters for the respective TRPs, the UE may select a TRP with the most favorable channel. The UE may then inform the network that it prefers the selected TRP in the case that the network determines to implement a fallback from SFN operation to a single-TRP scheme for that UE.

In another example, a UE may transmit a message including an indication of a preferred SFN scheme. That is, based on the UE’s determination of suitable channel parameters for the respective TRPs, the UE may select a preferred SFN scheme (e.g., single-TRP, transparent SFN, non-transparent SFN, etc.) to provide the UE with the best projected performance (e.g., throughput, etc.).

In various aspects, a UE may report such an indication of a preferred TRP, and/or an indication of a preferred SFN scheme, utilizing a variety of suitable transmission configurations. For example, a UE may transmit these indicia in a CSI report. Here, a network may configure a UE to include these indicia in a CSI report by transmitting to the UE suitable RRC parameters, which may be included in the reportQuantity field within the network’s transmission to the UE of the RRC message CSI-ReportConfig. For example, reportQuantity may be configured to include a parameter indicating a preferred TRP and/or a preferred SFN scheme (e.g., identified as cri-TRP). In another example, reportQuantity may be configured to re-purpose the existing parameter cri-RSRP to indicate a preferred TRP and/or a preferred SFN scheme.

In another example, a UE may transmit these indicia by applying a suitably cyclic-shifted sequence to an UL SRS transmission. Here, a network may configure a UE to utilize a selected sequence for its SRS by transmitting to the UE suitable RRC parameters. These parameters may be included, e.g., in a cyclicShift of transmissionComb field of the RRC message SRS-Resource. In this fashion, a network may provide for a UE to select from multiple values for a cyclic shift of a sequence it applies to an SRS. Here, different cyclic shift values may correspond to different TRP indexes, and/or different SFN scheme indexes. Accordingly, when a UE selects a preferred TRP or preferred SFN scheme, the UE may select a cyclic shift corresponding to the index of the preferred TRP or SFN scheme. Thus, the UE may apply the relevant sequence to an SRS transmission, where the sequence is configured according to the selected cyclic shift. A receiving TRP may then identify the UE’s preferred TRP or SFN scheme by determining the cyclic shift applied to a received SRS and mapping that cyclic shift to its associated TRP index or SFN scheme index.

In still another example, a UE may transmit these indicia by applying a selected sequence to an UL SRS transmission. Here, a network may configure a UE with multiple sequences that it may apply to an SRS by transmitting to the UE suitable RRC parameters. These parameters may be included, e.g., in a sequenceId field of the RRC message SRS-Resource. In this fashion, a network may provide for a UE to select from multiple sequences to apply to an SRS. Here, different sequences may correspond to different TRP indexes, and/or different SFN scheme indexes. Accordingly, when a UE selects a preferred TRP or SFN scheme, the UE may select a sequence corresponding to the index of the preferred TRP or SFN scheme. Thus, the UE may apply the selected sequence to an SRS transmission. A receiving TRP may then identify the UE’s preferred TRP or SFN scheme by determining the sequence applied to a received SRS and mapping that sequence to its associated TRP index or SFN scheme index.

And in still another example, a UE may explicitly transmit these indicia as layer 1 signaling, e.g., as uplink control information (UCI) on a PUCCH or PUSCH; as layer 2 signaling, e.g., as a MAC-CE; as layer 3 signaling, e.g., RRC signaling; or any other suitable higher-layer signaling. In this way, a receiving TRP may directly identify the UE’s preferred TRP or SFN scheme based on the received signaling.

FIG. 10 is a flow chart illustrating an exemplary process 1000 for a UE-assisted SFN scheme selection feature in accordance with some aspects of the present disclosure. As described below, some or all illustrated features may be omitted in a particular implementation within the scope of the present disclosure, and some illustrated features may not be required for implementation of all embodiments. In some examples, the process 1000 may be carried out by the network node 500 illustrated in FIG. 5. In some examples, the process 1000 may be carried out by the UE 600 illustrated in FIG. 6. In some examples, the process 1000 may be carried out by any suitable apparatus or means for carrying out the functions or algorithm described below.

At block 1002, a plurality of TRPs may each transmit one or more reference signals (e.g., CSI-RS, TRS, etc.). And at block 1004, a UE may measure the reference signals to determine one or more channel parameters for each of the plurality of TRPs, as described above. At block 1006, the UE may generate a selection metric for each of the TRPs, based on the determined channel parameters.

At block 1008, the UE may select one or more preferred TRPs, and/or one or more preferred SFN schemes, based on the generated selection metrics. And at block 1010, the UE may transmit information indicating the preferred TRP(s) and/or SFN scheme(s), as described above.

At block 1012, the network may determine to implement a change in an SFN scheme for the UE, based on any suitable parameters, such as, e.g., measurements of an SRS performed by respective TRPs. And at block 1014, the network may select a suitable SFN scheme for the UE based on the information indicating the preferred TRP(s) and/or SFN schemes.

### UE Indicates Its Capability Of Supporting Flexible SFN Scheme Switching/UE-Assisted SFN Scheme Switching

According to a further aspect of this disclosure, to support forward and backward compatibility, a UE may transmit or report its capability of supporting a SFN scheme switching feature such as one of those described herein. For example, a UE may transmit to a network a suitable UE capability information message to indicate its support of network-based SFN scheme flexibility and/or its support of UE-assisted SFN scheme flexibility, as described herein. If a network receives such a UE capability information message, the network may accordingly configure a UE to carry out a suitable SFN scheme flexibility feature as described herein.

### Further Examples Having a Variety of Features

Example 1: A method, apparatus, and non-transitory computer-readable medium for wireless communication in a single-frequency network (SFN). A receiving device receives a configuration message that includes multiple transmission configuration indicator (TCI) state parameters, corresponding to respective TCI states. The receiving device then receives and demodulates a downlink traffic channel based on only a subset of the TCI states, the subset having fewer TCI states than the plurality of TCI states.

Example 2: A method, apparatus, and non-transitory computer-readable medium of Example 1, wherein the subset of the TCI states consists of one TCI state.

Example 3: A method, apparatus, and non-transitory computer-readable medium of any of Examples 1 to 2, wherein the receiving device measures one or more channel parameters corresponding to each TCI state of the plurality of TCI states, and transmits a channel state information message based on the channel parameters.

Example 4: A method, apparatus, and non-transitory computer-readable medium of any of Examples 1 to 3, wherein the receiving device receives an indication that the configuration message includes multiple TCI states.

Example 5: A method, apparatus, and non-transitory computer-readable medium of any of Examples 1 to 4, wherein the receiving device receives an indication of a change in an SFN scheme.

Example 6: A method, apparatus, and non-transitory computer-readable medium of any of Examples 1 to 5, wherein the change in the SFN scheme is a fallback to a single-transmission reception point (TRP) scheme.

Example 7: A method, apparatus, and non-transitory computer-readable medium of any of Examples 1 to 6, wherein the receiving device receives an indication identifying one or more TCI states from among the multiple TCI states, as a set of main TCI states. Here, the subset of the TCI states is the set of main TCI states.

Example 8: A method, apparatus, and non-transitory computer-readable medium of any of Examples 1 to 7, wherein the receiving device transmits information indicating UE support of a SFN scheme switching feature.

Example 9: A method, apparatus, and non-transitory computer-readable medium for wireless communication in a single-frequency network (SFN) that includes multiple transmission reception points (TRP). A network node transmits on a downlink traffic channel to a user equipment (UE) using a first SFN scheme. The network node then receives channel measurement information corresponding to respective channels between the UE and each TRP. Based on the channel measurement information, the network node determines to change from the first SFN scheme to a second SFN scheme. Thus, the network node transmits an indication to the UE of a change of SFN scheme, and transmits on the downlink traffic channel to the UE using the second SFN scheme.

Example 10: A method, apparatus, and non-transitory computer-readable medium of Example 9, where the network node receives information indicating one or more transmission configuration indicator (TCI) states corresponding to one or more neighbor TRPs capable of operating in the SFN. The network node then transmits a configuration message to the UE, including multiple TCI states including the one or more TCI states.

Example 11: A method, apparatus, and non-transitory computer-readable medium of any of Examples 9 to 10, where the network node receives a channel state information (CSI) message from the UE, based on one or more channel parameters corresponding to each of the multiple TCI states. The network node configures further transmission of the downlink traffic channel to the UE based on the CSI message.

Example 12: A method, apparatus, and non-transitory computer-readable medium of any of Examples 9 to 11, where the second SFN scheme is a single-TRP scheme.

Example 13: A method, apparatus, and non-transitory computer-readable medium of any of Examples 9 to 12, where the network node is either one of the TRPs, or a SFN control node in communication with each one of the multiple TRPs.

Example 14: A method, apparatus, and non-transitory computer-readable medium of any of Examples 9 to 13, where the network node receives information indicating UE support of a SFN scheme switching feature.

Example 15: A method, apparatus, and non-transitory computer-readable medium for wireless communication in a single-frequency network (SFN) that includes multiple transmission reception points (TRP). A receiving device receives one or more reference signals (RS) from each of multiple transmission reception points (TRPs). Based on the RS(s), the receiving device determines a channel parameter corresponding to each respective TRP of the multiple TRPs. The receiving device then transmits a report including information based on the determined channel parameter corresponding to each respective TRP.

Example 16: A method, apparatus, and non-transitory computer-readable medium of Example 15, where in response to the report, the receiving device receives an indication of a change from a first SFN scheme to a second SFN scheme.

Example 17: A method, apparatus, and non-transitory computer-readable medium of any of Examples 15 to 16, where the receiving device determines one or more preferred SFN schemes, or one or more preferred TRPs of the multiple TRPs, based on the determined channel parameter corresponding to each respective TRP of the multiple TRPs. Here, the information based on the determined channel parameter includes information indicating the one or more preferred SFN schemes, or the one or more preferred TRPs.

Example 18: A method, apparatus, and non-transitory computer-readable medium of any of Examples 15 to 17, where the receiving device transmits information indicating UE support of a SFN scheme switching feature.

Example 19: A method, apparatus, and non-transitory computer-readable medium for wireless communication in a single-frequency network (SFN) that includes multiple transmission reception points (TRP). A network node receives a report from a user equipment (UE), the report including information based on channel measurements of respective channels between the UE and each TRP. In response to the report, the network node determines to change from a first SFN scheme to a second SFN scheme and transmits to the UE an indication of the change from the first SFN scheme to the second SFN scheme.

Example 20: A method, apparatus, and non-transitory computer-readable medium of Example 19, where the report includes information indicating one or more UE-preferred SFN schemes, and/or one or more UE-preferred TRPs.

Example 21: A method, apparatus, and non-transitory computer-readable medium of any of Examples 19 to 20, where the network node receives information indicating UE support of a SFN scheme switching feature.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication in a single-frequency network (SFN), the method comprising:
receiving a configuration message comprising a plurality of transmission configuration indicator (TCI) state parameters corresponding to a plurality of TCI states;
receiving a downlink traffic channel; and
demodulating the traffic channel based on only a subset of the TCI states, the subset consisting of fewer TCI states than the plurality of TCI states.

2. The method of claim 1, wherein the subset of the TCI states consists of one TCI state.

3. The method of claim 1, further comprising:
measuring one or more channel parameters corresponding to each TCI state of the plurality of TCI states; and
transmitting a channel state information message based on the channel parameters.

4. The method of claim 1, further comprising receiving an indication that the configuration message comprises a plurality of transmission configuration information (TCI) states.

5. The method of claim 1, further comprising receiving an indication of a change in an SFN scheme.

6. The method of claim 5, wherein the change in the SFN scheme comprises a fallback to a single-transmission reception point (TRP) scheme.

7. The method of claim 1, further comprising receiving an indication identifying one or more TCI states of the plurality of TCI states as a set of main TCI states, wherein the subset of the TCI states is the set of main TCI states.

8. The method of claim 1, further comprising:
transmitting information indicating UE support of a SFN scheme switching feature.

9. A method of wireless communication operable at a network node in a network capable of operating as a single-frequency network (SFN) comprising a plurality of transmission reception points (TRP), the method comprising:
transmitting on a downlink traffic channel to a user equipment (UE) utilizing a first SFN scheme;
receiving channel measurement information corresponding to respective channels between the UE and each TRP of the plurality of TRPs;
based on the channel measurement information, determining to change from the first SFN scheme to a second SFN scheme; and
transmitting an indication to the UE of a change of SFN scheme; and
transmitting on the downlink traffic channel to the UE utilizing the second SFN scheme.

10. The method of claim 9, further comprising:
receiving information indicating one or more transmission configuration indicator (TCI) states corresponding to one or more neighbor TRPs capable of operating in the SFN; and
transmitting a configuration message to the UE, the configuration message comprising a plurality of TCI states including the one or more TCI states.

11. The method of claim 10, further comprising:
receiving a channel state information (CSI) message from the UE, based on one or more channel parameters corresponding to each TCI state of the plurality of TCI states; and
configuring further transmission of the downlink traffic channel to the UE based on the CSI message.

12. The method of claim 9, wherein the second SFN scheme is a single-TRP scheme.

13. The method of claim 9, wherein the network node is one of:
a TRP of the plurality of TRPs, or
a SFN control node in communication with each TRP of the plurality of TRPs.

14. The method of claim 9, further comprising:
receiving information indicating UE support of a SFN scheme switching feature.

15. A method of wireless communication in a single-frequency network (SFN), comprising:
receiving one or more reference signals (RS) from each of a plurality of transmission reception points (TRPs);
based on the one or more RSs, determining a channel parameter corresponding to each respective TRP of the plurality of TRPs;
transmitting a report comprising information based on the determined channel parameter corresponding to each respective TRP of the plurality of TRPs.

16. The method of claim 15, further comprising:
in response to the report, receiving an indication of a change from a first SFN scheme to a second SFN scheme.

17. The method of claim 15, further comprising:
determining one or more preferred SFN schemes, or one or more preferred TRPs of the plurality of TRPs, based on the determined channel parameter corresponding to each respective TRP of the plurality of TRPs,
wherein the information based on the determined channel parameter comprises information indicating the one or more preferred SFN schemes, or the one or more preferred TRPs.

18. The method of claim 15, further comprising:
transmitting information indicating UE support of a SFN scheme switching feature.

19. A method of wireless communication operable at a network node in a network capable of operating as a single-frequency network (SFN) comprising a plurality of transmission reception points (TRP), the method comprising:
receiving a report from a user equipment (UE), the report comprising information based on channel measurements of respective channels between the UE and each TRP of the plurality of TRPs;
in response to the report, determining to change from a first SFN scheme to a second SFN scheme; and
transmitting to the UE an indication of the change from the first SFN scheme to the second SFN scheme.

20. The method of claim 19, wherein the report comprises information indicating one or more of:
one or more UE-preferred SFN schemes; or
one or more UE-preferred TRPs of the plurality of TRPs.

21. The method of claim 19, further comprising:
receiving information indicating UE support of a SFN scheme switching feature.

22. An apparatus for wireless communication in a single-frequency network (SFN), the apparatus comprising:
means for receiving a configuration message comprising a plurality of transmission configuration indicator (TCI) state parameters corresponding to a plurality of TCI states;
means for receiving a downlink traffic channel; and
means for demodulating the traffic channel based on only a subset of the TCI states, the subset consisting of fewer TCI states than the plurality of TCI states.

23. A network node configured for wireless communication in a network capable of operating as a single-frequency network (SFN) comprising a plurality of transmission reception points (TRP), the network node comprising:
means for transmitting on a downlink traffic channel to a user equipment (UE) utilizing a first SFN scheme;
means for receiving channel measurement information corresponding to respective channels between the UE and each TRP of the plurality of TRPs;
means for determining, based on the channel measurement information, to change from the first SFN scheme to a second SFN scheme; and
means for transmitting an indication to the UE of a change of SFN scheme; and
means for transmitting on the downlink traffic channel to the UE utilizing the second SFN scheme.

24. An apparatus for wireless communication in a single-frequency network (SFN), the apparatus comprising:
means for receiving one or more reference signals (RS) from each of a plurality of transmission reception points (TRPs);
means for determining, based on the one or more RSs, a channel parameter corresponding to each respective TRP of the plurality of TRPs;
means for transmitting a report comprising information based on the determined channel parameter corresponding to each respective TRP of the plurality of TRPs.

25. A network node configured for wireless communication in a network capable of operating as a single-frequency network (SFN) comprising a plurality of transmission reception points (TRP), the network node comprising:
means for receiving a report from a user equipment (UE), the report comprising information based on channel measurements of respective channels between the UE and each TRP of the plurality of TRPs;
means for determining, in response to the report, to change from a first SFN scheme to a second SFN scheme; and
means for transmitting to the UE an indication of the change from the first SFN scheme to the second SFN scheme.

26. A non-transitory computer-readable medium storing computer-executable code, comprising instructions for causing an apparatus to:
receive a configuration message comprising a plurality of transmission configuration indicator (TCI) state parameters corresponding to a plurality of TCI states;
receive a downlink traffic channel; and
demodulate the traffic channel based on only a subset of the TCI states, the subset consisting of fewer TCI states than the plurality of TCI states.

27. A non-transitory computer-readable medium storing computer-executable code, comprising instructions for causing a network node to:
receive a configuration message comprising a plurality of transmission configuration indicator (TCI) state parameters corresponding to a plurality of TCI states;
receive a downlink traffic channel; and
demodulate the traffic channel based on only a subset of the TCI states, the subset consisting of fewer TCI states than the plurality of TCI states.

28. A non-transitory computer-readable medium storing computer-executable code, comprising instructions for causing an apparatus to:
transmit on a downlink traffic channel to a user equipment (UE) utilizing a first SFN scheme;
receive channel measurement information corresponding to respective channels between the UE and each TRP of the plurality of TRPs;
based on the channel measurement information, determine to change from the first SFN scheme to a second SFN scheme;
transmit an indication to the UE of a change of SFN scheme; and
transmit on the downlink traffic channel to the UE utilizing the second SFN scheme.

29. A non-transitory computer-readable medium storing computer-executable code, comprising instructions for causing a network node to:
receive one or more reference signals (RS) from each of a plurality of transmission reception points (TRPs);
based on the one or more RSs, determine a channel parameter corresponding to each respective TRP of the plurality of TRPs;
transmit a report comprising information based on the determined channel parameter corresponding to each respective TRP of the plurality of TRPs.

30. An apparatus for wireless communication, comprising:
a processor;
a transceiver communicatively coupled to processor; and
a memory communicatively coupled to the processor,
wherein the processor is configured to:
receive a configuration message comprising a plurality of transmission configuration indicator (TCI) state parameters corresponding to a plurality of TCI states;
receive a downlink traffic channel; and
demodulate the traffic channel based on only a subset of the TCI states, the subset consisting of fewer TCI states than the plurality of TCI states.

31. An apparatus for wireless communication, comprising:
a processor;
a transceiver communicatively coupled to processor; and
a memory communicatively coupled to the processor,
wherein the processor is configured to:
transmit on a downlink traffic channel to a user equipment (UE) utilizing a first SFN scheme;
receive channel measurement information corresponding to respective channels between the UE and each TRP of the plurality of TRPs;
based on the channel measurement information, determieg to change from the first SFN scheme to a second SFN scheme;
transmit an indication to the UE of a change of SFN scheme; and
transmit on the downlink traffic channel to the UE utilizing the second SFN scheme.

32. An apparatus for wireless communication, comprising:
a processor;
a transceiver communicatively coupled to processor; and
a memory communicatively coupled to the processor,
wherein the processor is configured to:
receive one or more reference signals (RS) from each of a plurality of transmission reception points (TRPs);
based on the one or more RSs, determine a channel parameter corresponding to each respective TRP of the plurality of TRPs;
transmit a report comprising information based on the determined channel parameter corresponding to each respective TRP of the plurality of TRPs.

33. An apparatus for wireless communication, comprising:
a processor;
a transceiver communicatively coupled to processor; and
a memory communicatively coupled to the processor,
wherein the processor is configured to:
receive a report from a user equipment (UE), the report comprising information based on channel measurements of respective channels between the UE and each TRP of the plurality of TRPs;
in response to the report, determine to change from a first SFN scheme to a second SFN scheme; and
transmit to the UE an indication of the change from the first SFN scheme to the second SFN scheme.
